(19) United States
(12) Patent Application Publication
(10) Pub. No.: US 2015/0300430 A1
(43) Pub. Date: Oct. 22, 2015

(54) IMPROVED DISC BRAKE HAVING DOUBLE YOKE PLATES AND FIXED CALIPER

(71) Applicant: WUHAN YOUFIN AUTO. PARTS CO., LTD., Wuhan City, Hubei (CN)

(72) Inventors: Dianbin ZHU, Wuhan (CN); Lei WANG, Wuhan (CN); Yufeng WANG, Wuhan (CN); Fei CHEN, Wuhan (CN); Yanan CAI, Wuhan (CN); Wenfei MIN, Wuhan (CN); Qiong FU, Wuhan (CN); Na HE, Wuhan (CN)

(73) Assignee: WUHAN YOUFIN AUTO.PARTS CO., LTD, Wuhan, Hubei (CN)

(21) Appl. No.: 14/439,933

(22) PCT Filed: Oct. 30, 2013
(86) PCT No.: PCT/CN2013/086215

§ 371 Date: Apr. 30, 2015

(30) Foreign Application Priority Data
Nov. 1, 2012 (CN) 201210432204.3

(51) Int. Cl. F16D 65/00; F16D 65/097; F16D 55/22

(52) U.S. Cl. CPC F16D 65/0075; F16D 55/22; F16D 65/0979

(57) ABSTRACT

An improved disc brake having double-yoke plate and a fixed caliper; an inclined surface is disposed in a key groove on a caliper body; when the caliper body and the upper and lower plates are assembled, the supporting keys of the upper and lower plates of the caliper body are pressed via the inclined surfaces in the key groove, such that the caliper body applies an axial pressure away from a brake disc to the supporting keys during assembly, thus further improving the rigidity of the brake, and reducing the consumption of brake fluid.

### BACKGROUND

The present invention relates to the technical field of brakes, and in particular to an improved disc brake having double yoke plates and fixed caliper.

The demand of brake fluid under a certain pressure is a critical performance indicator to judge the performance of brake calipers. This value may be obtained by measuring the linear deformation and angular deformation of the caliper body under a certain rigidity and making conversion.

Taking a floating brake as an example, the bending rigidity is ensured by a caliper back. The bending of the caliper back results in linear deformation (in the direction of the caliper back) and angular deformation (“bell-mouth deformation”). The “bell-mouth deformation” will finally result in uneven pressure distribution on a friction plate: the radial outside of a brake disc has a high pressure and friction heat is concentrated on the radial outside so that it is likely to generate heat recession; however, the pressure near the center of the brake disc is low, which will result in eccentric wear of the friction plate in the radial direction and finally lead to the increase of fluid demand and dragging after pressure relief. This type of brake calipers have a piston only on one side of the brake disc, so that the caliper body is required to be able to slide in the axial direction of the brake disc to acquire the wear compensation and brake clearance of the friction plate. Sliding calipers needs suspension supports in some forms, usually guide pins. The clearance of a guide system is likely to make the caliper body vibrate, and potentially reduces the service life of the product and generates noise. As this caliper body needs to freely slide within its whole life cycle, it is a big challenge for design and thus becomes a subject of various designs.

In order to avoid this problem, a brake having calipers fixed with respect to pistons is introduced in the prior art, so that the sliding characteristics of conventional brakes having floating calipers may be avoided. Such a brake has two groups of pistons on two sides of a brake disc, respectively. The two groups of caliper bodies are arranged in a string on the periphery of the brake disc, and the side edges thereof are fastened across the brake disc via structural screws. Compared with the former brakes having floating calipers of a claw structure, the fixed caliper bodies on two sides can provide higher rigidity. One obvious advantage is that the fixed caliper bodies do not slid, contributing to solving the noise, vibration and comfort problems of a vehicle. In addition, as the piston on each side separately controls the return and brake clearance of the piston on this side, a brake having fixed calipers only needs to make the friction plate separate from the brake disc even if the friction plate fails to return automatically. Contrarily, a brake having floating calipers needs to overcome additional overall sliding resistance of the calipers to separate the friction plate from the brake disc. Therefore, with respect to the floating calipers, the contact and dragging of a brake having fixed calipers may be relieved or eliminated after braking pressure relief.

However, when a brake having fixed calipers is applied in a big brake disc and a big friction plate, the circumferential span of the brake having fixed calipers will be very large. Due to too large circumferential length, the bending rigidity may become a problem particularly when the caliper bodies are made from light-weight aluminum alloy with a low Young modulus.

In the prior art (for example, JP06-341470A), by introducing a lower reinforcing plate with a high modulus of section, the bending rigidity of the caliper bodies is increased. There is no upper plate present in this application and the caliper bodies are directly coupled together across the brake disc via several structural screws, resulting in large volume of caliper bodies, large depth of cylinder bores and requiring complicated processing. Furthermore, it is inconvenient to realize the standardized module design of the caliper bodies. Hence, in Application No. 201010142142.3, entitled “Disc Brake Having Double Yoke Plates and Fixed Calipers”, both for a big brake disc or a big friction plate, the rigidity of caliper bodies is increased to a certain extent and the demand of brake fluid is reduced.

However, as the feet of bearing key blocks have obviously perpendicular and deep cracks and the bearing surfaces have negative inclined angles, the left indentation shows that only the tops of the bearing key blocks are in contact with the side faces of the keyways. It is indicated that the bearing key blocks are in poor fit with the keyways. The bearing key blocks will have a considerable deformation when stressed, resulting in lengthened moment arm, reduced rigidity and increased fluid demand.

However, as the upper plate and the lower plate are usually stamping parts, the bearing surfaces of the bearing key blocks have low precision in geometrical tolerances such as perpendicularity and flatness. So do the keyways on the caliper bodies. Although the keyways are machining parts, there are also certain geometrical tolerances and roughness of machined surfaces. Thus, during assembling, there will be clearances between the bearing surfaces of the bearing keys and the keyways, that is, it is impossible to realize complete contact. During braking, with the increase of hydraulic pressure, these clearances or incomplete contact will generate certain elastic deformation and displacement, thereby resulting in the axial movement of both inner and outer sides of the caliper bodies in a direction away from the brake disc and directly increasing the fluid demand of the brake during high-pressure braking.

Therefore, in order to further effectively enhance the linear and angular rigidity of the brake and reduce the fluid demand of the brake, on the basis of Application No. 201010142142.3, entitled “Disc Brake Having Double Yoke Plates and Fixed Calipers”, improvements have been made to a disc brake having double yoke plates and fixed calipers through lots of innovative efforts and tests.

The modular design of yoke plate type calipers represents the advanced technology of “Green Science and Technology”. In such a design, the key components and parts may be renovated and reused. Moreover, the assembly may be easily decomposed into different material parts for recycling when it cannot be repaired.

### SUMMARY

An objective of the present invention is to, on the basis of Application No. 201010142142.3, entitled “Disc Brake Having Double Yoke Plates and Fixed Calipers”, provide an improved disc brake having double yoke plates and fixed calipers, to further improve the rigidity of a brake and reduce the demand of brake fluid.

To achieve the above objective, the present invention employs the following technical solutions.

An improved disc brake having double yoke plates and fixed calipers is provided, including a caliper body, a bearing plate and friction plate, the bearing plate including an upper plate and a lower plate, the caliper body including an inner caliper body and an outer caliper body which are mounted between the upper plate and the lower plate at intervals by fasteners, the upper plate and the lower plate each having a plurality of bearing keys, the caliper body having a plurality of keyways corresponding to the bearing keys, the bearing keys being positioned inside the keyways to bear a counterforce generated during brake clamping, wherein slopes are provided in the keyways on the caliper body; when the caliper body is assembled with the upper and lower plates, the bearing keys on the upper and lower plates of the caliper body are pressed via the slopes in the keyways, so that the bearing keys are subjected to an axial pressure applied by the caliper body far away from the brake disc during assembling.

According to the above technical solutions, with the bias (preload) generated during mounting, a gap between the working bearing interfaces resulted from machining defects (tolerance and roughness of a machined surface) may be eliminated, so that the deformation and displacement between the keys and keyways due to a braking force from the calipers are eliminated. The rigidity of the brake is further improved and the fluid demand of the brake is reduced.

According to an embodiment of the present invention, the slopes within the keyways are disposed on surfaces of the bearing keys and/or surfaces of the keyways, or, the slopes are disposed on different numbers of bearing keys or keyways to reduce elastic deformation between the bearing keys and the keyways resulted from calipers force load before perfect contact.

Wherein, the inner caliper body and the outer caliper body, as well as the upper plate and the lower plate, are fastened by rivets and/or bolts.

Wherein, the outer caliper body and the inner caliper body further include reinforcing ribs having a heat dissipation function.

Wherein, the lower plate further comprises protruded portions formed at two ends of a hollow portion of the lower plate.

Wherein, the friction plate has a sliding lug in contact with an upper plane of the upper plate, so that the radial position of the friction plate is controlled.

Wherein, the friction plate assures the lug thereof to fit onto the upper plate via one or more friction plate compression springs, and limiting grooves for fixing the friction plate compression springs are further provided on the friction plate.

Wherein, each of the friction plate compression springs has a middle portion and flank portions on two sides of the middle portion, two ends of the middle portion are mounted in the limiting grooves of the friction plate, and the flank portions on the two sides are pressed onto the lower surface of the upper plate.

Wherein, a contact point of the middle portion of each of the compression springs and the friction plate limiting grooves is inclined by a certain angle, so that the friction plate may be allowed to be separated from the brake disc after the clamp force is relieved, thereby relieving dragging.

Wherein, there may be one or more bearing keys and matched keyways at a position of the inner caliper body or the outer caliper body corresponding to the upper plate or the lower plate, and the slopes and the bearing surfaces may be two separate groups, that is, one group is with slopes only while the other group is with bearing surfaces only.

Wherein, before clamped by the caliper body, there is a certain interference in the inclined interfaces between the bearing keys and the keyways; after completely clamped by the caliper body, yield deformation is inevitably caused on material of one of the interfaces between the bearing keys and the keyways, and compels the keys to closely fit with the keyways on the bearing surfaces transmitting a braking force; and, right-angle corner of the bearing keys are resisted against the slopes of the keyways before assembly and embedded into the slopes after assembling in place.

When the hardness of the material of the bearing keys is higher than that of the material of the keyways and if the slopes are configured within the keyways, the right-angle corners of the bearing keys will be embedded into the slopes after assembling in place. However, such an embedment manner will hinder the conversion from radial pressure to axial bias. Only when the hardness of the material of the bearing keys is lower than that of the material of the keyways, the right-angle corners of the bearing keys will be deformed into slopes during assembling. Therefore, another good way is to, when the hardness of the material of the bearing keys is higher than that of the material of the keyways, design the slopes on the bearing keys. The convex angles of the keyways in such a design will be resisted against the slopes of the bearing keys before assembling, but these convex angles will be deformed into fitted slopes after assembling. Thus, efficiency of differentiation from the radial pressure assembling force to axial bias is high.

The bias contributes to eliminating the interface clearance resulted from imperfect machining (tolerance, roughness) and thus eliminating the displacement and deformation between the keys and keyways generated when clipping loads.

Generally, the upper and lower plates are made from steel plates of high strength and stiffness, and the caliper body is made from aluminum alloy of light weight and good workability. As the hardness of the keys is generally higher than that of the caliper body and only material of the keyways usually has yield deformation, the second application way serves as a primary example while the first way serves as a secondary example.

Tests on Fluid Demand

Test conditions: 1, no bias: the screws are tightened by 35 N·m, and the fluid demand of the caliper body at 6 MPa, 10 MPa and 12 MPa are measured; 2, the screws are tightened by 5 N·m, and a bias of 6 MPa is applied (bias preload generated by the slopes is replaced with adjustable hydraulic pressure), the screws are tightened by 35 N·m before pressure relief, and the fluid demand of the caliper body at 6 MPa, 10 MPa and 12 MPa are measured; 3, the screws are tightened by 5 N·m, and a bias of 12 MPa is applied, the screws are tightened by 35 N·m before pressure relief, and the fluid demand of the caliper body at 6 MPa, 10 MPa and 12 MPa are measured.

TABLE 1
Data from the tests

| | Fluid demand (ml) | | |
|---|---|---|---|
| Pipeline pressure (MPa) | No bias | Bias of 6 MPa | Bias of 12 MPa |
| 6 | 3.5 | 3.3 | 3.0 |
| 10 | 3.9 | 3.7 | 3.5 |
| 12 | 4.0 | 3.9 | 3.6 |

Beneficial Effects:

1. Due to the up-down displacement generated during assembling (via rivets, bolts or other methods), a left-right displacement is generated and then used to perform biasing (preloading) with the slopes to absorb the initially elastic deformation of the bearing surfaces.

2. During assembling, it is unnecessary to provide a bias as shown in the above tests or by additionally applying hydraulic pressure or by applying other tools, thereby saving the assembly time.

3. By the slopes within the keyways, the bias is increased, a part of clearances are eliminated, the rigidity is increased, and the fluid demand of the caliper body is reduced.

### BRIEF DESCRIPTION OF THE DRAWINGS

FIG. 1 is a cross-sectional view in a case where a caliper body of a brake is axially positioned with upper and lower plates by keys and keyways;

FIG. 2 is a partially enlarged cross-sectional view of FIG. 1, in a case where slopes are provided on the keyway surfaces only;

FIG. 3 is a cross-sectional view in a case where the caliper body of the brake is coupled with the upper and lower plates by rivets/screws; and

FIG. 4 is a cross-sectional view in a case where the slopes and bearing surfaces of the brake are in two separate groups, one group is with slopes while the other group is without slopes.

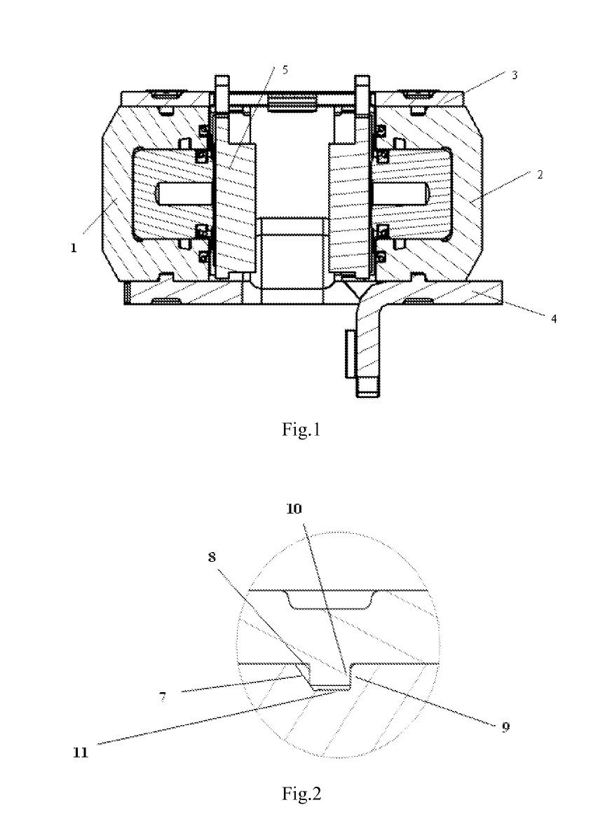

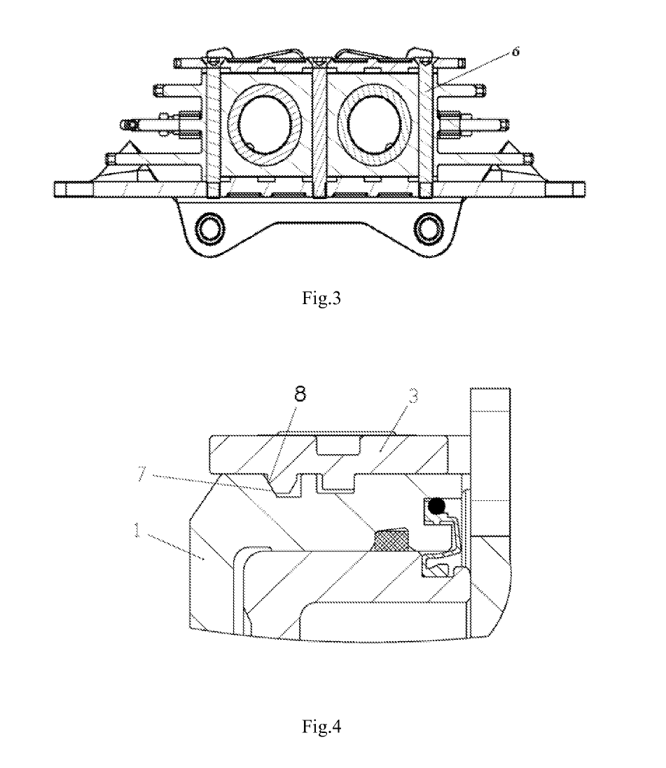

In the drawings: 1: Outer caliper body; 2: Inner caliper body; 3: Upper plate; 4: Lower plate; 5: Friction plate; 6: Coupling rivets/screws; 7: Slopes of keyways; 8: Straight surfaces of bearing keys; 9: Bearing surfaces of keyways; 10: Bearing surfaces of bearing keys; and 11: Keyways.

### DETAILED DESCRIPTION

### Embodiment 1

Convex angles are provided on surface portions on one side of keyways of a caliper body, and slopes are provided on bearing keys. When the caliper body is assembled with upper and lower plates, the convex angles in the keyways of the caliper body are pressed by the slopes 12 of the bearing keys, so that the bearing surfaces 9 of the keyways axially press the bearing surfaces 10 of the bearing keys, that is, the bearing keys are subjected to an axial pressure applied by the caliper away from the brake disc during assembling. Then, the caliper body 1, 2 and the upper and lower plates 3, 4 are fastened together via rivets or bolts 6. In this way, the clearance and deformation of the interfaces between the bearing keys and the keyways during braking are reduced, and the axial displacement of the caliper body in the direction away from the brake disc during braking is eliminated, so that the rigidity of the brake is enhanced and the fluid demand of the brake is reduced.

### Embodiment 2

Referring to FIG. 4, two groups of keys and keyways are provided on the upper plate of the outer caliper body. One group in which both the keyways and the corresponding keys have slopes is called a bias group, while the other group in which both the keys and the keyways have no slopes is called a bearing group. The two groups are arranged independently and separately. When the caliper body is assembled with upper and lower plates, the keys and keyways in the bearing group are closely fitted with each other on the bearing surfaces by the mutual compression of the slopes in the bias group. That is, the bearing keys in the bearing groups are subjected to an axial pressure applied by the caliper away from the brake disc during assembling. Then, the caliper body and the upper and lower plates are fastened together via rivets or bolts. In this way, the deformation of the interfaces between the bearing keys and the keyways during braking is reduced, and the axial displacement of the caliper body in the direction away from the brake disc during braking is reduced, so that the rigidity of the brake is enhanced and the fluid demand of the brake is reduced.

A person of ordinary skill in the art may design slopes on the keyways and/or on the bearing keys according to actual needs, and may provide one or more separate slope and bearing surface groups at a position of the caliper body corresponding to the upper plate or the lower plate thus to meet different needs.

Apparently, the foregoing descriptions and records are merely examples, and are not indented to limit the claimed contents, applications or use of the present invention. Although the embodiments have been described and illustrated in the drawings, a person of ordinary skill in the art may be appreciated that, various alterations and equivalents may be made for replacing the above components without departing from the protection scope of the present invention defined in the claims, and any deformation may be made according to the teaching of the present invention for adapting particular environments or materials without departing from the essential scope of the present invention. Therefore, it may be predicted that, the present invention is not limited to particular examples illustrated in the drawings and described in the specific embodiments as the present best modes for implementing the teaching of the present invention; instead, the scope of the present invention shall include any embodiment falling into the foregoing specification and the appended claims therein.

1. An improved disc brake having double yoke plates and fixed calipers, comprising: a caliper body, a bearing plate and a friction plate,
wherein the bearing plate comprises an upper plate and a lower plate, the caliper body comprises an inner caliper body and an outer caliper body which are mounted between the upper plate and the lower plate at intervals by fasteners, each of the upper plate and the lower plate has a plurality of bearing keys, the caliper body has a plurality of keyways corresponding to the bearing keys, the bearing keys are positioned inside the keyways to bear a counterforce generated from brake clamping,
wherein slopes are provided in the keyways on the caliper body and/or on the bearing keys of the bearing plates,
wherein during mounting, a part of material is yielded when clamped by a radial force, and the yield force produces an axial bias between the working bearing surfaces of the keys and keyways via the slopes.

2. The brake according to claim 1, wherein the slopes within the keyways are disposed on surfaces of the bearing keys and/or surfaces of the keyways, or, the slopes are disposed on different numbers of bearing keys or keyways, to reduce elastic deformation between the bearing keys and the keyways resulted from a force from the calipers before perfect contact.

3. The brake according to claim 1, wherein the inner caliper body and the outer caliper body, as well as the upper plate and the lower plate, are fastened by separate or integral rivets and/or bolts.

4. The brake according to claim 1, wherein the outer caliper body and the inner caliper body further comprise reinforcing ribs having a heat dissipation function.

5. The brake according to claim 1, wherein the lower plate further comprises protruded portions formed at two ends of a hollow portion of the lower plate.

6. The brake according to claim 1, wherein the friction plate has a sliding lug in contact with an upper plane of the upper plate, so that the radial position of the friction plate is controlled.

7. The brake according to claim 6, wherein the friction plate assures the lug thereof to fit onto the upper plate via one or more friction plate compression springs, and limiting grooves for fixing the friction plate compression springs are further provided on the friction plate.

8. The brake according to claim 7, wherein each of the friction plate compression springs has a middle portion and flank portions on two sides of the middle portion, two ends of the middle portion are mounted in the limiting grooves of the friction plate, and the flank portions on the two sides are pressed onto the lower surface of the upper plate.

9. The brake according to claim 8, wherein a contact point of the middle portion of each of the compression springs and the limiting grooves of the friction plate is inclined by a certain angle.

10. The brake according to claim 2, wherein there may be one or more bearing keys and matched keyways at a position of the inner caliper body or the outer caliper body corresponding to the upper plate or the lower plate, and the slopes and the bearing surfaces may be set to two separate groups, that is, one group is with slopes only while the other group is with bearing surfaces only.

11. The brake according to claim 2, wherein, before the yoke plates are clamped by the caliper body, there is a certain interference in the inclined interfaces between the bearing keys and the keyways; after the completely clamped by the caliper body, yield deformation is caused on material of one of the inclined interfaces between the bearing keys and the keyways, and this yield force compels the keys to closely fit with the keyways on the bearing surfaces transmitting a braking force; and, right-angle corners of the bearing keys are resisted against the slopes of the keyways before assembly and embedded into the slopes after assembling in place.

12. The brake according to claim 11, wherein the bearing keys are disposed in the yoke plates while the keyways are disposed on the caliper body, or, the keyways are disposed in the yoke plates while the bearing keys are placed on the caliper body.
